(19) United States
(12) Patent Application Publication
(10) Pub. No.: US 2005/0159779 A1
(43) Pub. Date: Jul. 21, 2005

(54) Soft disposable pacifier attacher

(76) Inventors: Elchonon Schwartz, Brooklyn, NY (US); Esther E. Schwartz, Brooklyn, NY (US)

Correspondence Address: Esther E. Schwartz, 1898 Ocean Avenue, Brooklyn, NY, 11230, US

(21) Appl. No.: 10/760,973

(22) Filed: Jan. 20, 2004

(51) Int. Cl. A61J 17/00

(52) U.S. Cl. 606/234

(57) ABSTRACT

A disposable pacifier attacher comprising a strap of a disposable, resilient, material such as plastic with an adhesive portion at the top, and a means for detachably attaching a pacifier to the pacifier attacher at the bottom. The adhesive portion at the top is used to detachably attach the strap to a baby's garment. The detachable attaching means at the bottom is used to detachably attach a pacifier to the strap. In the preferred embodiment, the top adhesive containing portion is larger than the width of the remaining length of the strap and is formed into a shape, such as a circle or star. The pacifier is attached to the strap by placing the bottom of the strap through the pacifier handle, and using the adhesive provided at the end of the strap to secure the end of the strap to a portion of the strap containing a non-stick material for easy removal of the pacifier when disposing of the pacifier attacher. Non-stick paper is provided to cover the adhesive portions until needed.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISC

Not Applicable

### BACKGROUND OF THE INVENTION

(1) Field of the Invention

This invention relates to baby pacifier accessories. More particularly, this invention relates to disposable, comfortable pacifier attachers.

(2) Description of the Related Art Including Information Disclosed Under 37 CFR 1.97 and 1.98

Baby pacifiers as well as pacifier retaining devices are well known in the prior art. A pacifier is a baby device many caregivers could not live without. Pacifier retaining devices have also become a practical necessity for many caregivers and babies. Pacifier retaining devices provide a means for securing a pacifier within a baby's reach. Often such a device will be attached to a baby's clothing. A pacifier retaining device has many benefits. Babies know where the pacifier is and can choose to use it whenever they want to. The pacifier drops to the floor less often, keeping it more sanitary. The pacifier will be lost less often, reducing caregiver and baby's aggravation at not having it when they need it.

Pacifier retaining devices have continually been improved on, providing a shorter cord to prevent accidental strangulation and eliminating necklace-type attachers that also pose strangulation risks.

There are two problems that still exist in the current art. The first is the means of attaching the device to the infant's clothing. In all of the prior art a clip or fastener of varying materials is used. The clip or fastener is necessarily of a minimum thickness and hardness. For example, U.S. Pat. No. 4,903,698 discloses a pacifier strap and fastener for attachment to a garment with a clamp and a slit for detachable attachment to the clothing of an infant. U.S. Pat. No. 4,972,980 discloses a pacifier holder with an ornamental front surface with an integral snap lock means connected with the rear surface. This pacifier holder is removably attached to a baby's clothing by placing a piece of fabric of the infant's clothing between the ornamental member and the snap ring. U.S. Pat. No. 4,990,157 discloses a soother retainer consisting of a plastic retaining strap in combination with a one piece plastic clip. U.S. Pat. No. 4,994,075 discloses an infant pacifier holder assembly consisting of a cord with a distal end that engages a clip member that can be clipped to the clothes of an infant. In addition, there are many other methods of attaching a pacifier retaining device to an infant's clothing that are utilized in the current art, such as metal or plastic clips or fasteners of varying construction and safety pins.

Because the cord portion of the pacifier retaining device cannot be longer than a length deemed safe against a strangulation hazard, the clip must be secured to the upper front portion of a baby's garment. As a baby rolls over during the night, the clip will press into the baby's soft skin. To prevent this, the pacifier retaining device must be removed during the night. But if babies lose their pacifiers during the night, the caregiver will have to get out of bed to find it, losing the great advantage of a pacifier retaining device. U.S. Pat. No. 3,392,729 discloses a two-part fastener element separable to receive a puckered portion of the fabric of the garment. This stud-type fastener is slightly less uncomfortable, but the small piece that separates can be pulled off and present a choking hazard. Therefore, such a fastener is not entirely satisfactory. Pacifier retaining devices that have a button-hole as the means of attachment are not entirely satisfactory either, because not all baby garments contain buttons in appropriate places for attachment.

The second problem is the unsanitary nature of the pacifier retaining devices in the current art. Food and dirt get caught along the cord and inside every crevice of the clip portion. Most pacifier retaining devices are impossible to adequately clean and sanitize.

There is a need for an improved pacifier retaining device that is both more comfortable for the baby and more sanitary.

Our invention solves both those problems with a soft disposable pacifier attacher. This novel pacifier attacher contains no hard parts and lays completely flat against the baby's body for superior comfort during sleep and waking hours. The disposable aspect of this pacifier attacher makes it a convenient, sanitary, and worry-free option for caregivers.

It is therefore an object of the present invention to provide a means for detachably attaching a pacifier to a baby's clothing that is more comfortable for the baby.

It is a further object of the present invention to provide a more sanitary means for detachably attaching a pacifier to a baby's clothing.

It is a further object of the present invention to provide a means for detachably attaching a pacifier to a baby's clothing that is convenient and practical.

### BRIEF SUMMARY OF THE INVENTION

We have invented a soft disposable pacifier attacher. The major portion of the pacifier attacher comprises a strap of a flexible material such as plastic. At one end is a substantially flat means for detachably attaching the soft disposable pacifer attacher to a baby's garment, and at the opposite end is a means for detachably attaching a pacifier to the pacifier attacher. The substantially flat means for detachably attaching the pacifier attacher to a baby's garment is a repositionable fabric-adhering adhesive material that will not destroy the fabric when removed. The flexible material is preferably both durable and disposable. In the preferred embodiment, the means for detachably attaching a pacifier to the pacifier attacher is an adhesive material provided at the bottom of the strap. The pacifier is attached to the strap by placing the bottom of the strap through the pacifier handle, and using the adhesive provided at the end of the strap to secure the end of the strap to a portion of the strap containing a non-stick material. This provides for easy removal of the pacifier when disposing of the pacifier attacher, or simply changing the pacifier. Non-stick paper is provided to cover the adhesive portions until needed. Alternate embodiments would provide alternative means for attaching the pacifier to the strap, such as opposing attaching means or a permanent loop, and alternate substantially flat means for affixing the strap to a baby's garment. The top fabric-adhering adhesive containing portion, in the preferred embodiment, is larger than the width of the remaining length of the strap. It can be formed into a shape, such as a circle or star.

### BRIEF DESCRIPTION OF THE SEVERAL VIEWS OF THE DRAWINGS

FIG. 1. is a front view of the embodiment of the invention in FIG. 3, 4, or 5. affixed to a baby's garment and the baby's pacifier.

FIG. 2. is a perspective view of the front of an alternate embodiment of the pacifier attacher containing a permanent loop at the bottom for an alternate means of attaching the pacifier to the pacifier attacher.

FIG. 3. is a back view of a preferred embodiment of the invention, showing the adhesive portion at the top, non-stick material covering the adhesive portion, and the two opposing attaching means on the strap, Velcro-type fasteners in this embodiment, that will be connected to removably hold the pacifier.

FIG. 4. is a back view of an alternate embodiment of the pacifier attacher containing an adhesive material at the lower end of the strap to detachably attach the pacifier to the strap.

FIG. 5. is a back view of an alternate embodiment of the pacifier attacher containing two opposing attaching means on the strap, snap-type fasteners in this embodiment, that will be connected to removably hold the pacifier.

### DETAILED DESCRIPTION OF THE INVENTION

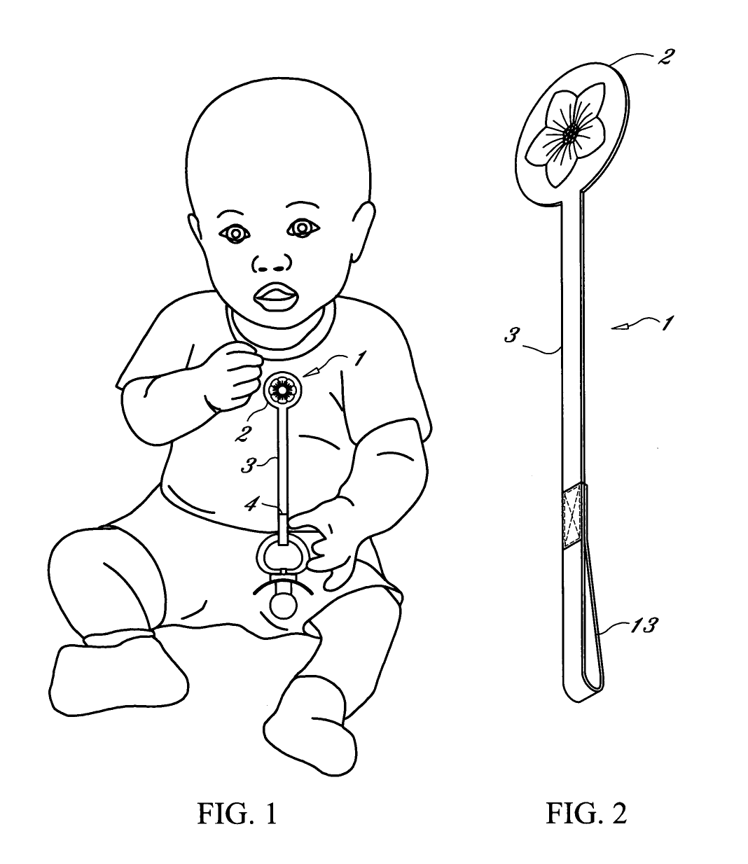

The invention, as depicted in FIGS. 1-5, generally comprises a pacifier attacher 1 of a flexible material such as plastic, preferably disposable and resilient, with a substantially flat adhering material 5 as the means for detachably attaching the pacifier attacher, such as an adhesive material, at the top 2, and a means for attaching the pacifier to the pacifier attacher 1 at the bottom of the strap 3. The substantially flat adhering material 5 at the top 2 is used to detachably attach the pacifier attacher to a baby's garment. The means for attaching the pacifier located at the bottom of the strap 3 is used to detachably attach a pacifier to the strap 3.

The length of the entire device once the pacifier is secured is within the standard well known in the art, which requires the strap to be short enough not to pose a strangulation hazard, but long enough to provide the baby freedom of movement when the pacifier is in the baby's mouth. All materials used in making this device should be non-toxic and soft, posing no risk of poisoning or injury due to hard metal or plastic parts.

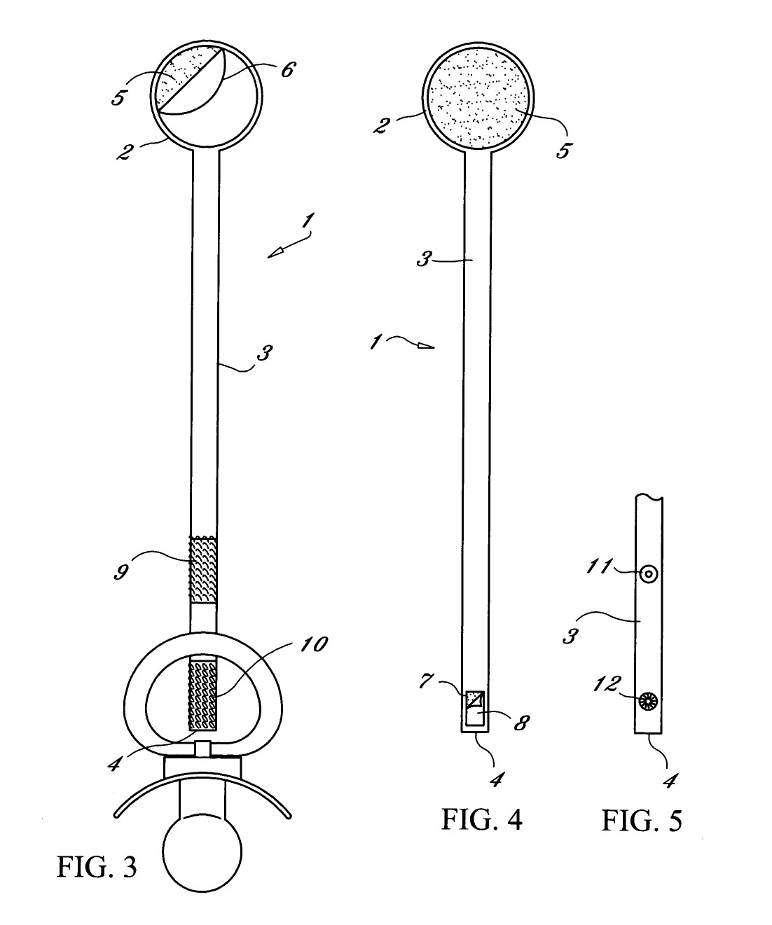

FIG. 1. is a front view of the invention affixed to a baby's garment with the pacifier attaching means on either FIG. 3, 4, or 5. The pacifier attacher 1 comprises a top 2 and a strap 3. The pacifier is detachably attached by looping the end 4 through a handle or hole on the pacifier, and detachably attaching a portion closer to the end 4 to another portion on the strap 3. The preferred embodiment contains a design on the front face of the top 2. The top 2 can be formed into any shape or can be of uniform width throughout, making the top 2 continuous with the strap 3. The top 2 and strap 3 should be formed from one uniform material to which the attachment means are affixed to prevent the top from being separated from the strap, posing a choking hazard.

FIG. 2. is a perspective view of the front of an alternate embodiment of the pacifier attacher containing a permanent loop at the bottom for an alternate means of attaching the pacifier to the pacifier attacher. The pacifier attacher 1 comprises a top 2 and a strap 3. The top 2 contains a substantially flat adhering material 5 on its back, not visible in this figure. The means for detachably attaching the pacifier to the strap 3 in this embodiment comprises a permanent loop 13 at the bottom of the strap 3. The permanent loop 13 can be formed by bending the end of the strap up to a higher point on the remaining portion of the strap and permanently affixing the end of the strap 3 to a higher point on the strap 3. Alternatively, the device can be made in one continuous piece containing a loop portion at the bottom. The pacifier should be detachably attached before the device is affixed to a baby's garment, and before removal of the non-stick paper over the adhesive portion, if any. The pacifier is attached by feeding the permanent loop 13 through the handle of the pacifier or a hole anywhere on the pacifier. The top portion of the pacifier attacher is then pulled through the loop.

FIG. 3. is a back view of a preferred embodiment of the invention. The pacifier attacher 1 comprises a strap 3 with a top 2 and an end 4. The top 2 contains a substantially flat adhering material 5. In this embodiment, the substantially flat adhering material 5 is sticky, and a non-stick material 6 is provided to cover the substantially flat adhering material 5. Two opposed attaching means 9, 10 are provided as the means for detachably attaching the pacifier in this embodiment. The opposed attaching means 9, 10 shown in this figure are hook and pile fasteners but can be any sufficient opposed attaching means.

The opposed attaching means 9, 10 represented in FIG. 3. generally comprise two corresponding points on the strap 3 on which two opposed attaching means 9,10 are provided, so that when the two points meet a loop is formed through which the pacifier is secured. The opposed attaching means 9, 10 can consist of any combination of standard fastening materials available in the industry. Some examples include Velcro-type fasteners, plastic snap fasteners, and magnetic strip fasteners. One point can contain an adhesive, and the corresponding point can contain a non-stick region for easy removal. FIG. 5. portrays an alternate opposed attaching means comprising two snap-type fasteners 11, 12. The snap-type fasteners 11, 12 are located substantially near the end 4 of the strap 3. There is a sufficient length of strap 3 between the snap-type fasteners 11, 12, to hold a handle of a pacifier.

FIG. 4. is a back view of an alternate embodiment of the pacifier attacher. The pacifier attacher 1 comprises a strap 3 with a top 2 and an end 4. The top 2 contains a substantially flat adhering material 5 for detachably attaching the pacifier attacher to a baby's garment. This repositionable fabric-adhering adhesive material will not destroy the fabric when removed. The material shown in this embodiment is not sticky and need not be covered with a protective non-stick material. This figure portrays an alternate pacifier attaching means comprising an adhesive 7 located substantially near the end 4 of the strap 3. The adhesive 7 is covered by a non-stick material 8 to protect the adhesive 7 until use. The pacifier is retained by feeding the end 4 through a handle or hole in the pacifier, removing the non-stick material 8, and detachably attaching the adhesive 7 to any portion of the remaining length of the strap 3. The strap 3 is preferably of a material that the adhesive 7 can be easily detached from, such as a non-stick material.

The top 2 should be large enough to effectively secure the weight and length of the combined pacifier and pacifier attacher 1. The term substantially flat adhering material refers to an adhesive material that is not confined to acrylic or sticky adhesives, and should adhere to most baby garments. The substantially flat adhering material 5 should be strong enough to effectively secure the pacifier attacher 1 until removal, but able to be easily removed without causing damage to ordinary baby clothing. If the adhesive is strong enough, the top 1 need not be wider than the strap 3. In the preferred embodiment, the top 2 is larger than the remaining length of the strap 3, and is formed into a shape. The entire pacifier attacher 1, the top 2 only, or no portion at all can be decorated using non-toxic child-friendly materials with colors and designs. These designs can include licensed characters, logos, and designs.

The strap 3 can be made of any durable, flexible, lightweight, inexpensive material to achieve the goals of disposability, comfort, and ease of use. Preferably, the material used will be substantially water and tear resistant. In the preferred embodiment, the material used will be a plastic of sufficient thickness to not be torn easily, but thin enough to be both flexible and disposable. The strap portion is of any effective width. If the top adhesive containing portion is made separately, it must be permanently and securely affixed to the strap portion so that the top portion cannot be ripped off, posing a choking hazard.

The substantially flat adhering material 5 is preferably 3M™ Removable Grip Fabric Tape. Its unique textured surface grips fabric securely, yet releases without damaging the fabric. The grip side contains synthetic polyolefin. Similar results can be achieved with Res Q Tape™ double-sided clear adhesive tape. It clings to fabric, and leaves no residue. Alternatively, the substantially flat adhering material can be any repositionable acrylic that is strong enough to hold the weight of the pacifier but easily removed. The substantially flat adhering material can be any substantially flat material that will removably adhere to fabric without causing damage and hold the weight of a standard pacifier.

The substantially flat adhering material 5 can be directly applied to the top 2 of the strap 3. Alternatively, the substantially flat adhering material 5 can be applied using a double-sided adhesive tape, or double sided foam tape, the first side adhering to the top 2 of the strap 3, the second side available to adhere to the baby's clothing. A non-stick material, such as a glossy paper, will be provided to protect the adhesive portion until use. The adhesive need not be sticky. It can be any substantially flat adhering material, including a Velcro-type of looped fixative material, to achieve the goals of a comfortable flat fit against the baby, remaining in place until removed, and easy removal from the baby's garment. The material should preferably be disposable, but can also be reusable. Ordinary adhesive cannot be lifted and readjusted many times once affixed, as it loses its adhering ability. Therefore it would be beneficial to use a substantially flat material that can be readjusted many times, like 3M™ Removable Grip Fabric Tape or Velcro-type fixatives, to allow for more versatility in adjustment of the pacifier attacher on the baby's clothing. This would also allow the pacifier attacher to be reused until soiled, and then be disposed.

The means for detachably attaching the pacifier to the strap 3 can be any effective means that is cost-efficient due to the disposable nature of the assembly, and light enough to be supported by the adhesive 5 at the top 2 when detachably attached to a garment.

The means can consist of an adhesive material. The adhesive portion is placed at the lowest point of the device. The bottom portion of the ribbon is threaded through the handle of the pacifier, and the adhesive is affixed to a corresponding point on the ribbon, thereby removably securing the pacifier to the pacifier attacher.

Any portion of the pacifier attacher can be stuffed with a soft packing such as cotton, or filled with any material. The top adhesive containing portion can be made thicker or puffier than the remaining length of the strap for superior comfort, durability, or support. The pacifier attacher can be provided in sterile packaging. This packaging can consist of any means known in the art, including individual paper wrappers similar to those used to package sterile adhesive bandage strips.

We have illustrated a preferred embodiment of the invention. However, it is to be understood that changes and variations may be made by those skilled in the art without departing from the spirit of the invention as claimed.

Many variations of the invention will occur to those skilled in the art. All such variations are intended to be within the scope and spirit of the invention. Although some embodiments are shown to include certain features, we specifically contemplate that any feature disclosed in this description may be used together or in combination with any other feature on any embodiment of the invention. We have also contemplated that any feature may be specifically excluded from any embodiment of an invention.

Further aspects of the invention will become apparent from consideration of the drawings and the description of preferred embodiments of the invention. A person skilled in the art will realize that other embodiments of the invention are possible and that the details of the invention can be modified in a number of respects, all without departing from the inventive concept. Thus, the drawings and description are to be regarded as illustrative in nature and not restrictive.

### LIST OF REFERENCE NUMBERS

1. Pacifier Attacher
2. Top
3. Strap
4. End
5. Substantially flat adhering material
6. Non-stick material
7. Adhesive material
8. Non-stick material
9. Opposed attaching means
10. Opposed attaching means
11. Snap-type fastener
12. Snap-type fastener
13. Loop

1. A Pacifier Attacher comprising:
a. A length of a flexible material with two opposite extremes;
b. The first extreme containing an adhesive material to detachably attach said flexible material to a baby's garment; and
c. The second extreme containing a means for attaching a pacifier to said flexible material.

2. A Pacifier Attacher comprising:
a. A length of a flexible material with two opposite extremes;
b. The first extreme containing a substantially flat means to detachably attach said flexible material to a baby's garment comprising a repositionable adhering material that will not destroy the baby's garment when removed; and
c. The second extreme containing a means for attaching a pacifier to said flexible material.

3. The pacifier attacher of claim 2 in which said substantially flat means is an adhesive capable of detachably attaching to fabric.

4. The pacifier attacher of claim 2 in which said substantially flat means is a reusable fabric grip attaching means capable of detachably attaching to fabric.

5. The pacifier attacher of claim 2 in which said substantially flat means is a disposable fabric grip attaching means capable of detachably attaching to fabric.

6. The pacifier attacher of claim 2 in which said flexible material is disposable.

7. The pacifier attacher of claim 2 in which said first extreme containing a substantially flat means to detachably attach said flexible material to a baby's garment is formed into a design or shape.

8. The pacifier attacher of claim 2 in which said means for attaching a pacifier to said flexible material comprises at least one adhesive portion substantially near said second extreme of said flexible material for the purpose of detachably attaching said second extreme to any portion of the remaining flexible material to form a loop to sufficiently retain a pacifier.

9. The pacifier attacher of claim 2 in which said means for attaching a pacifier to said flexible material comprises a permanent loop at said second extreme of said flexible material for the purpose of detachably attaching a pacifier to said flexible material by pushing said permanent loop through a hole or handle on a pacifier, and then pulling the pacifier attacher through said permanent loop.

10. The pacifier attacher of claim 2 in which a non-stick material is provided to cover adhesive portions until use.

11. The pacifier attacher of claim 2 in which said pacifier attacher is provided in sterile packaging.

12. The pacifier attacher of claim 2 in which said flexible material is resilient.

13. The pacifier attacher of claim 2 in which said flexible material is waterproof.

14. The pacifier attacher of claim 2 in which said flexible material is plastic.

15. The pacifier attacher of claim 2 in which said flexible material is decorated in a child-friendly manner.

16. The pacifier attacher of claim 2 in which any portion of said flexible material is stuffed with another material.

17. The pacifier attacher of claim 2 in which said first extreme is thicker than the remaining length of said flexible material.

18. The pacifier attacher of claim 2 in which said first extreme is wider than the remaining length of said flexible material.

19. The pacifier attacher of claim 2 in which said flexible material is of the same width throughout.

20. A Pacifier Attacher comprising:
a. A length of a flexible material with two opposite extremes;
b. The first extreme containing a substantially flat means to detachably attach said flexible material to a baby's garment comprising a repositionable adhering material that will not destroy the baby's garment when removed; and
c. The second extreme containing a means for attaching a pacifier to said flexible material comprising at least two opposed attaching means; a first attaching means substantially closer to said second extreme of said flexible material than a second attaching means for the purpose of detachably attaching said first attaching means to said second attaching means to form a loop to sufficiently retain a pacifier.

21. The pacifier attacher of claim 20 in which said opposed attaching means comprises opposed hook and pile fasteners.

22. The pacifier attacher of claim 20 in which said opposed attaching means comprises opposed snap members.

23. The pacifier attacher of claim 20 in which said opposed attaching means comprises an adhesive containing portion and a non-stick portion for easy removal of pacifer.
